(19) United States
(12) Patent Application Publication
(10) Pub. No.: US 2026/0109203 A1
(43) Pub. Date: Apr. 23, 2026

(54) DYNAMICALLY CONTROLLING GLARE USING ANTIGLARE PROJECTION TO REDUCE IMPACT OF THE GLARE TO THE DRIVER

(71) Applicant: Volvo Car Corporation, Göteborg (SE)

(72) Inventors: Axel Bouvier, Göteborg (SE); Thomas Bernichon, Göteborg (SE); Matthias Yannick Philippe Le Saux, Göteborg (SE); Mariam Frenning, Göteborg (SE)

(21) Appl. No.: 18/924,060

(22) Filed: Oct. 23, 2024

(51) Int. Cl. B60J 3/02; B60J 3/04; B60K 35/10; B60R 1/29

(52) U.S. Cl. CPC B60J 3/02; B60J 3/04; B60K 35/10; B60R 1/29; B60R 2300/108

(57) ABSTRACT

Various embodiments are disclosed showing techniques for mitigating glare to a driver of a vehicle using an onboard computing system of the vehicle are provided. For example, a method can comprise detecting glare on a window from an external light source, displaying a virtual window on an infotainment system whereby allowing a driver or occupant to manually select a portion of the virtual window to block the glare and projecting an anti-glare image on the window to darken glare spots identified on the virtual window.

### TECHNICAL FIELD

The disclosed subject matter relates to vehicles (e.g., transportation vehicles), and more particularly, to a glare mitigation system for vehicles.

### BACKGROUND

Windshield glare refers to the reflection of light off the surface of a vehicle's windshield, which can create visual discomfort or impair the driver's ability to see clearly. Glare typically occurs when sunlight or headlights from other vehicles hit the windshield at certain angles, causing light to bounce off the glass and into the driver's eyes. This glare can reduce visibility and increase the likelihood of accidents.

To mitigate windshield glare, drivers can use sun visors, polarized sunglasses, or adjust their seating position to minimize direct exposure to the light source. Hower, these manual techniques may not be effective in many scenarios depending on source and direction of the incoming light.

The above-described background relating to windshield glare is merely intended to provide a contextual overview of some current issues and is not intended to be exhaustive. Other contextual information may become further apparent upon review of the following detailed description.

### SUMMARY

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, systems, devices, computer-implemented methods, apparatuses and/or computer program products that facilitate automatically mitigating glare to vehicle drivers.

As alluded to above, improved techniques for mitigating windshield glare are desirable, and various embodiments are described herein to this end and/or other ends.

According to an embodiment, a system can comprise a memory that stores computer executable components, and a processor that executes the computer executable components stored in the memory, including a glare detection component that detects glare on a window from an external light source, a display component that displays a virtual window on an infotainment system whereby allowing a driver or occupant to manually select a portion of the virtual window to block the glare and a glare blocking component that projects an anti-glare image on the window to darken glare spots identified on the virtual window.

According to another embodiment, a method can comprise detecting, by a system onboard a vehicle comprising a processor, glare on a window from an external light source, displaying, by the system, a virtual window on an infotainment system whereby allowing a driver or occupant to manually select a portion of the virtual window to block the glare and projecting, by the system, an anti-glare image on the window to darken glare spots identified on the virtual window. In various embodiments, the method further comprises generating, by the system, an image covering one or more glare spots based on information from the glare detection component and activating, by the system, one or more components when glare is detected.

According to yet another embodiment, a non-transitory machine-readable medium can comprise executable instructions that, when executed by a processor integrated on or within a vehicle, facilitate performance of operations, comprising, detecting glare on a window from an external light source, displaying a virtual window on an infotainment system whereby allowing a driver or occupant to manually select a portion of the virtual window to block the glare, projecting, by the system an anti-glare image on the window to darken glare spots identified on the virtual window, generating an image covering one or more glare spots based on information from the glare detection component, and activating one or more components when glare is detected.

### BRIEF DESCRIPTION OF DRAWINGS

FIG. 1 illustrates a block diagram of an exemplary system that facilitates mitigating glare to a driver of a vehicle, in accordance with one or more embodiments described herein.

FIG. 2 illustrates various examples vehicle window glare scenarios in accordance with one or more embodiments described herein.

FIGS. 3A and 3B illustrate an example implementation of a vehicle glare mitigation system in accordance with one or more embodiments described herein.

FIGS. 4A-4C illustrate examples of a vehicle window incorporating smart film or smart glass technology, in accordance with one or more embodiments described herein.

FIG. 5 illustrates an example vehicle incorporating a glare mitigation system in accordance with one or more embodiments described herein.

FIGS. 6A and 6B illustrate an example graphical user interface of a vehicle glare mitigation system that facilitates localizing a glare position on one or more windows of a vehicle, in accordance with one or more embodiments described herein.

FIG. 7 illustrates a block diagram of, additionally, or alternatively, exemplary system 100 that facilitates mitigating glare to a driver of a vehicle, in accordance with one or more embodiments described herein.

FIG. 8 illustrates a block flow diagram of an example, non-limiting computer-implemented method for that facilitates mitigating glare to a driver of a vehicle, in accordance with one or more embodiments described herein.

FIG. 9 illustrates a block flow diagram of another example, non-limiting computer-implemented method for that facilitates mitigating glare to a driver of a vehicle, in accordance with one or more embodiments described herein.

FIG. 10 is an example, non-limiting computing environment in which one or more embodiments described herein can be implemented.

FIG. 11 is an example, non-limiting networking environment in which one or more embodiments described herein can be implemented.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

As alluded to above, improved techniques for mitigating windshield glare are desirable, and various embodiments are described herein to this end and/or other ends. In accordance with one or more embodiments, the disclosed solution provides an advanced glare mitigation system for vehicles that facilitates automatically mitigating windshield glare, as well as glare associated with other windows of the vehicle, by an onboard computer system of a vehicle.

In various embodiments, the onboard computer system of the vehicle can comprise a memory that stores computer-executable components, and a processor that executes the computer executable components stored in the memory. These computer-executable components include a glare localization component that determines and tracks a glare position on one or more windows of the vehicle attributed to a glare to a driver of the vehicle, and an antiglare component that controls an antiglare device integrated on or within the vehicle to cause the antiglare device to minimize light reflected or transmitted through the one or more windows at the glare position.

In some embodiments, the antiglare device comprises a switchable window film positioned on or within respective surfaces of the one or more windows, and wherein the antiglare component controls an opacity level of a region of the switchable film corresponding to the glare position to minimize the light reflected or transmitted through the one or more windows at the glare position. Additionally, or alternatively, the antiglare device comprises an adjustable mirror and wherein the antiglare component electrically controls and adjusts a position and orientation of the adjustable mirror to cause the adjustable mirror to deflect the light reflected or transmitted through the one or more windows at the glare position to minimize the light reflected or transmitted through the one or more windows at the glare position. Additionally, or alternatively, the antiglare device comprises a light projection device that projects a glare minimizing light, and wherein the antiglare component controls the light projection device to cause the light projection device to project the glare minimizing light onto the one or more windows at the glare position to minimize the light reflected or transmitted through the one or more windows at the glare position.

The mechanism or mechanisms via which the glare localization component determines and tracks the glare position can vary. In some embodiments, the glare localization component determines and tracks the glare position based on the current field of view (FOV) of the driver and respective angles and intensities of light beams transmitted or reflected through the one or more windows relative to the current FOV of the driver or respective eyes of the driver. To facilitate this end, the glare localization component can determine and track the current FOV of the driver using one or more cameras located on or within the vehicle. The glare localization component can also determine the respective angles and intensities of the light beams using one or more light sensors located on or within the vehicle. For example, the one or more light sensors can be integrated on or within a wearable device worn by the driver, the one or more windows, and/or another physical component of the vehicle.

Additionally, or alternatively, the glare localization component can determine and tracks the glare position based on reception of input from the driver or a passenger of the vehicle indicating the glare position. For example, in some implementations, the input comprises gesture input corresponding to pointing to the glare position or temporarily directing the driver's line of sight toward the glare position. Additionally, or alternatively, the input comprises a selection of the glare position on a graphical representation of the one or more windows as displayed via a touchscreen display device positioned within the vehicle.

In some embodiments, the disclosed techniques can also incorporate artificial intelligence (AI) to facilitate inferring whether and when the driver is experience glare, and the glare position of the glare on one or more windows of the vehicle, based on the context of the vehicle and/or the driver. To this end, the context can account for potential sources of glare (e.g., the sun, light beams of another vehicle, light beams from another external source, etc.), the relative position of the vehicle with respect to the potential sources of glare, the time of day, the FOV of the driver, the seat position of the driver, the route of the vehicle, and other contextual factors.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It will be understood that when an element is referred to as being “coupled” to another element, it can describe one or more different types of coupling including, but not limited to, chemical coupling, communicative coupling, capacitive coupling, electrical coupling, electromagnetic coupling, inductive coupling, operative coupling, conductive coupling, acoustic coupling, ultrasound coupling, optical coupling, physical coupling, thermal coupling, and/or another type of coupling. As referenced herein, an “entity” can comprise a human, a client, a user, a computing device, a software application, an agent, a machine learning model, an artificial intelligence, and/or another entity. It should be appreciated that such an entity can facilitate implementation of the subject disclosure in accordance with one or more embodiments described herein.

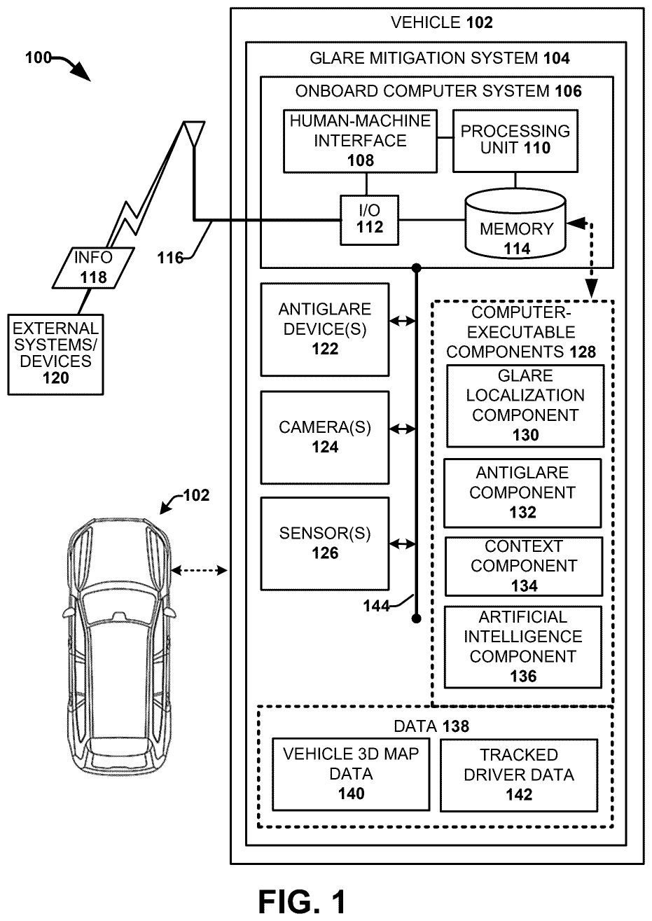

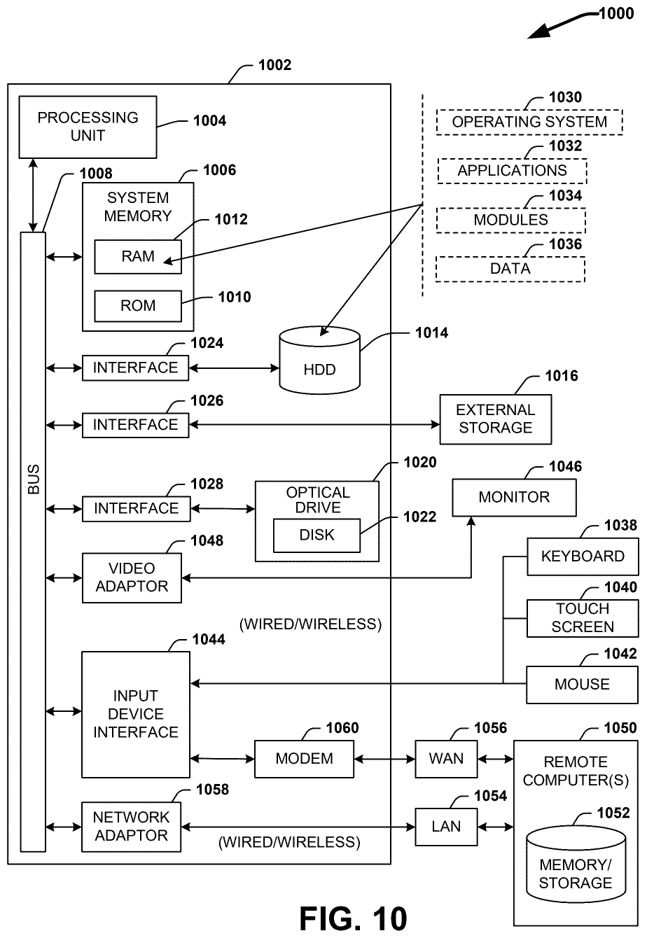

Turning now to the drawings, FIG. 1 illustrates a block diagram of an exemplary system 100 that facilitates mitigating glare to a driver of a vehicle, in accordance with one or more embodiments described herein. System 100 includes a vehicle 102 comprising a glare mitigation system 104 integrated thereon or therein. The glare mitigation system 104 includes one or more antiglare devices 122, one or more cameras 124, one or more sensors 126 and an onboard computer system 106. The onboard computer system 106 comprises at least one memory 114 that stores computer-executable components 128 and data 138 that facilitate automatically mitigating glare to a driver of vehicle 102 (and/or one or more passengers of the vehicle 102). These computer-executable components include (but are not limited to) glare localization component 130, antiglare component 132, context component 132 and artificial intelligence (AI) component 136. The onboard computer system 106 includes at least one processor or processing unit 110 that executes the computer-executable component 128 stored in memory 114 to carry out the operations/functions described with respect to the corresponding computer-executable components. Examples of said memory 114, processing unit 110, and other computer system components that can be included in the onboard computer system 106 to facilitate the various features and functionalities of system 100 can be found with reference to FIG. 10 (e.g., system memory 1010, processing unit 1004, and the like).

The onboard computer system 106 can further include an input/output (I/O) component 112, wherein the I/O component 112 can be a transceiver configured to enable transmission/receipt of information 118 between the onboard computer system 106 and various external systems or devices 120. For example, the external systems or devices 120 can correspond to any type of device or computing system configured to wirelessly communicate (e.g., using radio frequency signals) with the onboard computer system 106, such as but not limited to, a mobile device associated with one or more users of the vehicle 102 (e.g., a smartphone, a smartwatch, a tablet, eyewear, a wearable headset or another type of wearable device), an external computer, an external computer system, an external application server, another vehicle's onboard computer system, and so on. The I/O component 112 can be communicatively coupled, via an antenna 116, to the remotely located devices and systems (e.g., external systems/devices 120). Any suitable technology can be utilized to enable the various embodiments presented herein, regarding transmission and receiving of information 118 between the onboard computer system 106 and one or more external systems/devices 120. Suitable technologies include BLUETOOTH®, cellular technology (e.g., 3G, 4G, 5G), internet technology, ethernet technology, ultra-wideband (UWB), DECAWAVE®, IEEE 802.15.4a standard-based technology, Wi-Fi technology, Radio Frequency Identification (RFID), Near Field Communication (NFC) radio technology, and the like.

The onboard computer system 106 can also include a human-machine interface 108 that provides for receiving user input in association with utilizing the various features and functionalities of the computer-executable component 134 and presenting information to users. For example, the human-machine interfaces 108 can include or correspond to any suitable output device such as a display, a speaker, etc. and any suitable input device, such as a touchscreen display, a microphone, a keypad, a keyboard, a camera, a gesture input device/system, a voice input device/system, and the like. Examples of suitable input and output devices of the human-machine interface 108 devices are further provided with reference to FIG. 10. The glare mitigation system 104 also include a system bus 144 that communicatively and operatively couples the onboard computer system 106, the one or more antiglare device 122, the one or more cameras 126 and the one or more sensors 126 to one another using any suitable wired or wireless communication technology.

Vehicle 102 can correspond to any type of transportation vehicle comprising one or more windows and adapted for use in scenarios in which glare to one or more passengers (e.g., the driver and/or other passengers) as cause by light transmitted thorough and/or reflected off of the one or more windows. For instance, vehicle 102 can include or correspond to any type of motor vehicle (e.g., a car, a truck, a van, a sport utility vehicle (SUV), etc.). In some implementations vehicle 102 can also include or correspond to an aircraft (e.g., an airplane, a helicopter, or the like), a watercraft, or another type of passenger transportation vehicle. In some embodiments, vehicle 102 can include or correspond to an autonomous vehicle that is capable of navigating and operating without (or some) human input.

As used herein, the term “glare” refers to the sensation of visual discomfort or reduced visibility to a person caused by an excessively bright light source. Glare can be experienced by the driver and/or one or more passengers of a vehicle in response to light beams, caused by natural (e.g., the sun) and artificial light sources (e.g., interior lights of the vehicle 102, lights of other vehicles), passing through or reflecting off of one or more window of the vehicle and into the driver's/passenger's eyes or FOV, causing visual discomfort or impaired vision. For example, direct glare can occur when a bright light source is directly in the line of sight, causing discomfort or temporary blindness. For instance, looking directly at the sun or oncoming headlights (e.g., while driving at night) through the windshield can produce direct glare. Reflected glare occurs when light reflects off surfaces such as water, snow, glass, or shiny objects and into the driver's FOV through the windshield or other windows of the vehicle, creating bright spots or streaks that can impair vision. This type of glare is common when driving on wet roads or when sunlight reflects off the surface of the vehicle's windshield and/or other windows of the vehicle.

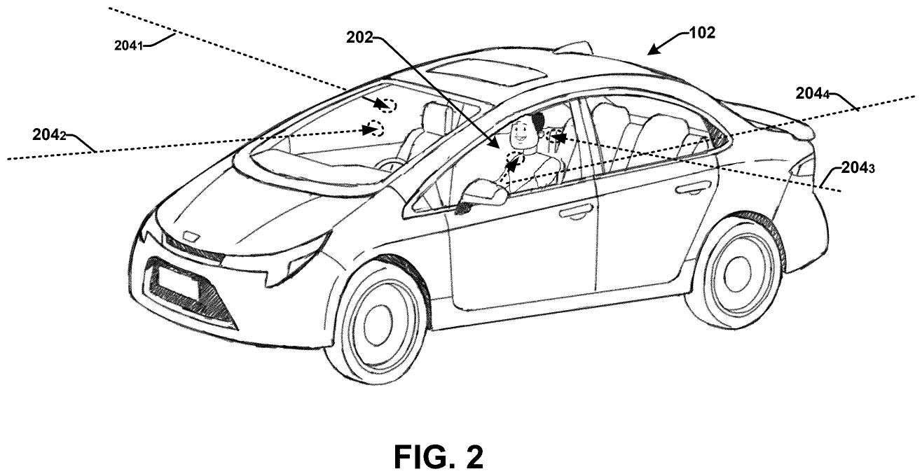

For example, FIG. 2 illustrates various examples vehicle window glare scenarios in accordance with one or more embodiments described herein. As illustrated in FIG. 2, vehicle 102 includes a driver 202 positioned within the driver's seat in association with operating/driving the vehicle 102. FIG. 2 presents various dashed arrowed lines 204₁₋₄ corresponding to light beams that may cause glare to the driver 202 in association with the light beams reflecting off of and/or being transmitted through the windshield of the vehicle 102, as well as the front left and right windows of the vehicle 102, and into the driver's eyes/FOV. For example, dashed line 204₁ corresponds to a light beam hitting the front, right-side window of vehicle 102, dashed line 204₂ corresponds to a light beam hitting the windshield of vehicle 102, and dashed lines dashed lines 204₃ and 204₄ correspond to light beams hitting the front left-side window of vehicle 102. More particularly, dashed line 204₄ corresponds to a light beam hitting the front left-side window of vehicle 102 as reflected off the front left-side door mirror, which can be attributed to headlights of another vehicle located behind vehicle 102 when driving at night. The dashed circles illustrated on the respective windows indicate the position or point on the respective windows at which the respective light beams hit the respective windows, referred to as the point of incidence. In this regard, when a light beam strikes a window, the point where it intersects the surface is often referred to as the “point of incidence.” This is the location where the light transitions from traveling through one medium (usually air) to another (the material of the window, such as glass). The angle at which the light strikes the window relative to the normal (perpendicular) to the surface is known as the angle of incidence.

Depending on the point of incidence, the angle of incidence, the intensity of the respective light beams, the angle of the respective windows, the material of the respective windows, and the FOV or position of the diver's eyes relative to the respective windows, these light beams may be reflected through and/or off of the respective windows at the point of incidence and cause glare to the driver 202 of the vehicle 102. When this occurs, the point of incidence on the window is referred to herein as the glare point or glare position.

With reference to FIGS. 1 and 2, in accordance with various embodiments, the glare localization component 130 can identify or determine and track a glare position on one or more windows of vehicle 102 attributed to a glare to the driver 202 of the vehicle caused by light beams (e.g., light beams corresponding to dashed lines 2041-4 for example) striking one or more windows of the vehicle 102. In some embodiments, the glare localization component 130 can also identify or determine and track a glare position on one or more windows of the vehicle 102 attributed to a glare to another passenger of the vehicle 102 other than the driver, such as a passenger sitting in any position within vehicle 102. The one or more windows can include any windows of the vehicle and are not limited to the front left/right windows and the windshield, as illustrated in FIG. 2. The antiglare component 132 can further control one or more antiglare devices 122 integrated on or within the vehicle 102 to cause the one or more antiglare devices 122 to minimize (e.g., block, partially block, reduce, filter, deflect, etc.) light reflected or transmitted through the one or more windows at the glare position, thereby mitigating the glare.

For example, in some embodiments, the one or more antiglare devices 122 include or correspond to a switchable film (also referred to as a smart film or privacy film) positioned on or within respective surfaces (e.g., internal and/or external surfaces) of the one or more windows of vehicle 102, and wherein the antiglare component 132 controls an opacity level of a region of the switchable film corresponding to the glare position to minimize the light reflected off or transmitted through the one or more windows at the glare position. In this regard, a switchable window film (or simply switchable film, smart film, privacy film and/or variations thereof), refers to an electrically controlled film for window tinting that can be electrically controlled to adjust its opacity or tint level. A switchable film is a thin laminate film that can be applied to existing glass surfaces. The switchable film is typically composed of multiple layers, including a conductive layer, a polymer layer, and sometimes a liquid crystal layer. The conductive layer contains materials such as indium tin oxide (ITO) or metal nanoparticles that can conduct electricity. This layer is applied to the surface of the glass and serves as the electrode for the film. The polymer layer contains suspended particles or molecules that can change their alignment or orientation in response to an electric field. This layer is sandwiched between the conductive layer and an additional protective layer. Some electrically controlled window films may include a liquid crystal layer. Liquid crystals can change their optical properties when subjected to an electric field, allowing the film to switch between varying degrees of opaque and transparent states. The electrically controlled window tinting film is connected to a power source and a controller (e.g., which in accordance with the disclosed techniques corresponds to the antiglare component 132 of the onboard computer system 106) typically via wires or wireless communication. The controller controls application of an electric voltage across the conductive layer from the power source, wherein the strength (e.g., voltage level) and/or direction (e.g., polarity) of the applied electric current controls the degree to which the opacity/tint level of the film is increased or decreased. For example, lower voltages typically result in a more transparent or lighter tint, while higher voltages make the film more opaque or darker.

Alternatively, the one or more windows of the vehicle 102 can be formed out of smart class. Smart glass technology is similar to the switchable film technology described above. Smart glass is a type of glass that incorporates an electrochromic or suspended particle device (SPD) technology directly into the glass itself. It also consists of multiple layers, including conductive coatings and active materials. By applying an electric current, the glass changes its light transmission properties, transitioning from transparent to translucent or opaque.

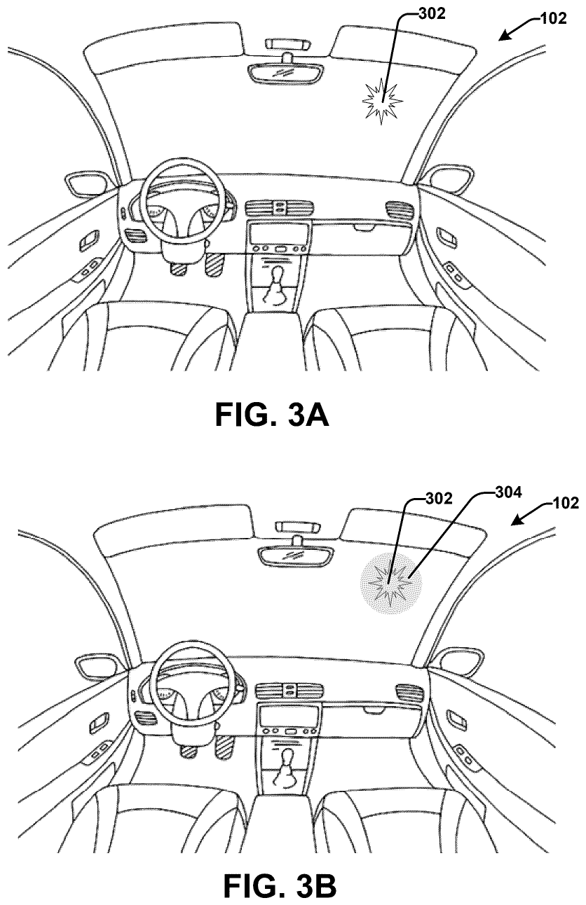

In accordance with one or more embodiments in which the one or more antiglare devices 122 include or correspond to switchable window films that cover and/or line the surfaces of one or more windows of the vehicle (e.g., the windshield, the front-left window, the front-right window and/or other windows of the vehicle 102), and/or in in which the windows are formed out of smart glass, the switchable film or smart glass on each window can be electrically controlled by the antiglare component 132 to adjust its opacity or tint level in different areas or regions independently such that the opacity or tint level of only a portion of the switchable film or smart glass corresponding to the glare position (and glare region size) can be temporarily increased as needed to minimize light transmitted or reflected at the glare position (e.g., based on the intensity of the light/glare). In other words, the glare localization component 130 can identify or determine a glare position on a window of the vehicle 102 and the antiglare component 132 can increase the opacity or tint level of a portion or region of the switchable film corresponding to the glare position, as illustrated in FIGS. 3A and 3B.

In this regard, FIGS. 3A and 3B illustrate an example implementation of a vehicle glare mitigation system (e.g., glare mitigation system 104) in accordance with one or more embodiments described herein. FIGS. 3A and 3B provide a perspective of a driver of vehicle 102 (or a passenger of the vehicle) as the driver would be positioned within the driver's seat. The driver is removed from the illustration shown in FIGS. 3A and 3B for ease of illustration. With reference to FIGS. 1-3B, in accordance with the example shown in FIGS. 3A and 3B, the one or more antiglare devices 122 correspond to a switchable film that lines respective surfaces of the windshield and the front right and left windows of the vehicle 102, or smart glass that forms the windshield and the front and left windows. As shown in FIG. 3A, the opacity level of the entirety of the switchable film or smart glass is set to a default opacity level (e.g., a transparent opacity level or another defined default opacity level). With reference to FIGS. 1-3B, as illustrated in FIG. 3A, the glare localization component 130 has determined a glare position 402 on the windshield of the vehicle 102 attributed to a glare to the driver of the vehicle. As shown in FIG. 3B, based on detecting glare to the driver and determining the corresponding glare position 302, the antiglare component 132 can electrically control a portion 304 of the switchable film or smart glass on the windshield corresponding to the glare position 302 to cause only the portion 304 of the switchable film or the smart glass to increase in opacity, thereby blocking or minimizing glare to the driver.

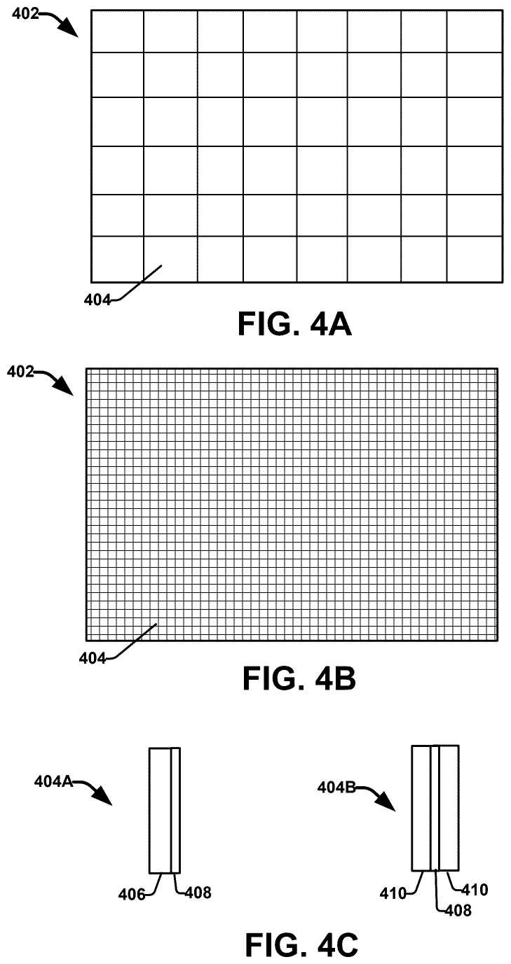

To facilitate this end, the switchable film or smart glass can be discretized into a plurality of different cells or pieces that can be independently controlled, as illustrated in FIGS. 4A and 4B. In this regard, FIGS. 4A and 4B respectively illustrate an example window of vehicle 102 in accordance with one or more embodiments. With reference to FIGS. 1-4C, window 402 can correspond to any windows of vehicle 102, such as the windshield, the front left window, the front right windows, and/or other windows of vehicle 102. In some embodiments, window 402 can comprise a smart film or switchable film formed on the interior or exterior surface of the window that can be electrically controlled by the antiglare component 132. In other embodiments, the window 402 can be formed out of smart glass. In either case, the smart film or the smart glass can be discretized into a plurality of different cells 404 that can be independently controlled by the antiglare component 132 to increase and decrease its opacity or tint level. The degree of discretization and thus the size of the respective cells can vary, as illustrated with respect to FIGS. 4A and 4B. FIG. 4C presents cross-sectional views of a single cell 404 of window 402. In particular, cell 404A corresponds to the embodiment wherein window 402 comprises a smart film or switchable film formed thereon. With these embodiments, each cell 404 can correspond to cell 404A and include an independently controllable cell of smart film 408 form on the existing glass of the window. Cell 404B corresponds to the embodiment wherein window 402 is formed out of smart glass. With these embodiments, each cell 404 can correspond to cell 404A and include an independently controllable cell of smart film 408 sandwiched between opposing layers of clear glass 410.

To this end, the shape and size of the region or portion of the switchable film or smart window adjusted to have an increased opacity or tint level can vary. For example, as illustrated in FIG. 3B, the shape of the portion 304 of the switchable film or smart window adjusted is circular and has a diameter corresponding to the size of the light beam causing the glare at the glare position 302. It should be appreciated that shape of the portion of the switchable film or smart window adjusted is constrained as a function of the level of discretization (and thus size) of the cells 404. For instance, in an implementation in which the level of discretization corresponds to that illustrated in FIG. 4A, the shape of the portion of the switchable film or smart window adjusted will be rectangular or square, while smaller cells provide for more freedom in tailoring the shape and size of the portion adjusted into other shapes such as circular shapes and other uniform and non-uniform shapes.

In some embodiments, the size and shape of the portion of the switchable film or smart window adjusted can be set to a default shape or size such that all cells 404 located within a defined radius of the glare position are adjusted. In other embodiments, the size and shape of the portion of the switchable film or smart window adjusted can based on the size/dimensions of the glare region, such that all cells comprising any portion of the glare region are adjusted. To this end, the glare region refers to the geometrical region of the window attributed to the glare, which can vary in size depending on intensity of the light beam causing the glare, the source of the light beam, the direction and angle at which the light beam hits the window at the glare position, and the like. In some embodiments, in association with determining the glare position, the glare localization component 130 can also determine and/or define the shape and/or dimensions of the glare region, and the antiglare component 132 can adjust (e.g., increase the opacity or tint level) of the corresponding cells 404 accordingly.

The antiglare component 132 can also dynamically adjust the opacity or tint level of the switchable window film or the smart window as the glare position and/or glare region moves and/or changes in size over the course of operation of the vehicle, as determined in real-time or substantially real-time by the glare localization component 130. For example, as the vehicle changes position/orientation and/or as the source of the glare changes position/orientation, the glare position and/or glare region size may change and/or the glare to the driver may decrease or entirely cease. To this end, the antiglare component can 132 can dynamically increase and decrease the opacity level of different areas or regions of the one or more windows of the vehicle in real-time as needed based on whether the driver is experiencing glare and the current position and region of the glare on the one or more windows of the vehicle.

Additionally, or alternatively, the one or more antiglare devices 122 can comprise one or more adjustable mirrors (e.g., motorized adjustable mirrors), and wherein the antiglare component 132 electrically controls and adjusts a position and orientation of the adjustable mirror to cause the adjustable mirror to deflect the light reflected or transmitted through the one or more windows at the glare position to minimize the light reflected or transmitted through the one or more windows at the glare position.

Additionally, or alternatively, the one or more the antiglare devices 122 can comprise a light projection device that projects a glare minimizing light onto the one or more windows at the glare position and/or glare region, and wherein the antiglare component controls the light projection device to cause the light projection device to project the glare minimizing light onto the one or more windows at the glare position to minimize the light reflected or transmitted through the one or more windows at the glare position.

The mechanism or mechanisms via which the glare localization component 130 identifies or determines and tracks the glare position on one or more windows of the vehicle 102 can vary. As described above with reference to FIG. 2, whether a light beam hitting a window of the vehicle within the FOV of the driver (e.g., the windshield and the front left and right windows) causes a glare to the driver depends on the intensity of the light beam, the point of incidence, the angle of incidence, and the relative FOV of the driver or the relative position of the drivers eyes with respect to the window.

In some embodiments, the glare localization component 130 can determine and track a glare position and/or glare region on a window of the vehicle 102 using one or more cameras 124 positioned on or within the vehicle 102 and/or one or more sensors 126 positioned on or within the vehicle 102. For example, in some embodiments, using image data captured via one or more cameras positioned on or within the vehicle 102, the glare localization component 130 can determine and track the current FOV of the driver 202 and/or the current position and orientation of the driver's eyes relative to respective surfaces of the one or more windows. The glare localization component 130 can further determine and track a glare position based on a current FOV the driver and respective angles and intensities of light beams transmitted or reflected through the one or more windows relative to the current FOV of the driver 202 or respective eyes of the driver. The glare localization component 130 can also determine the respective angles and intensities of the light beams based on analysis of image data captured of the light beams via the one or more cameras and/or corresponding angles and intensities of the light beams as received at one or more light sensors (e.g., included amongst the one or more sensors 126) located on or within the vehicle.

For example, one or more light sensors can be integrated on or within at least one of, a wearable device worn by the driver (e.g., on or near the driver's eyes/head), the one or more windows, or another physical component of the vehicle. The glare localization component 130 can also use predefined spatial reference data for the vehicle 102 to facilitate determining the relative positions and orientations of the driver's eyes/FOV with respect to the vehicle windows, the relative trajectories of light beams causing the glare to the driver through the one or more windows and the driver's eyes/FOV, and thus the corresponding glare position of the light beams on respective surfaces of the one or more windows (e.g., using triangulation or other 3D mapping and localization algorithms).

In this regard, the defined spatial reference data can include or correspond to a three-dimensional map or model of the vehicle that (e.g., represented in FIG. 1 as vehicle 3D map data 140) that defines the spatial relationships between respective physical elements of the vehicle in accordance with a defined 3D space, including relative positions and orientations of respective physical elements of the vehicle to one another on or within the defined 3D space. Based on analysis of image data captured of the driver's face/eyes, the glare localization component 130 can determine the relative position and orientation of the driver's eyes within the 3D space and thus the relative position/orientation of the driver's eyes with respect to the surfaces of the one or more windows. The glare localization component 130 can similarly determine respective angles and intensities of light beams received at one or more cameras and/or one or more light sensors positioned within the vehicle and using triangulation algorithms or the like, determine the corresponding glare position on the one or more windows.

In this regard, the one or more cameras 124 can include at least one camera positioned within the vehicle that provides a field of view of the driver's face relative to other internal physical components of the vehicle (e.g., the driver's seat, the driver's window, the roof of the vehicle, one or more back seats of the vehicles, etc.). In accordance with this example embodiment, using a camera positioned with a perspective of the driver's face, the camera can capture image data of the driver which can be used to determine and track the driver's FOV and/or the position of the driver's eyes. For example, based on image data captured of the driver's face, the glare localization component 130 can determine and track the current FOV of the driver (and/or other passengers of the vehicle). The glare localization component 130 can also determine the FOV and/or position of the driver's eye relative to respective windows (e.g., the front windshield, the front right side window, the front left side window, and/or other windows) based on analysis of the image data and defined spatial reference data for the vehicle 102. In this regard, the defined spatial reference data can include or correspond to a three-dimensional map or model of the vehicle that (e.g., represented in FIG. 1 as vehicle 3D map data 140) that defines the spatial relationships between respective physical elements of the vehicle, including relative positions and orientations of respective physical elements of the vehicle to one another. To this end, based on analysis of the image data of the driver's face and known spatial relationships between the back of the driver's seat and the respective windows of the vehicle as provided in the vehicle 3D map data 140, the glare localization component 130 can determine or infer the relative position and orientation of the driver's eyes and thus their current FOV within the vehicle.

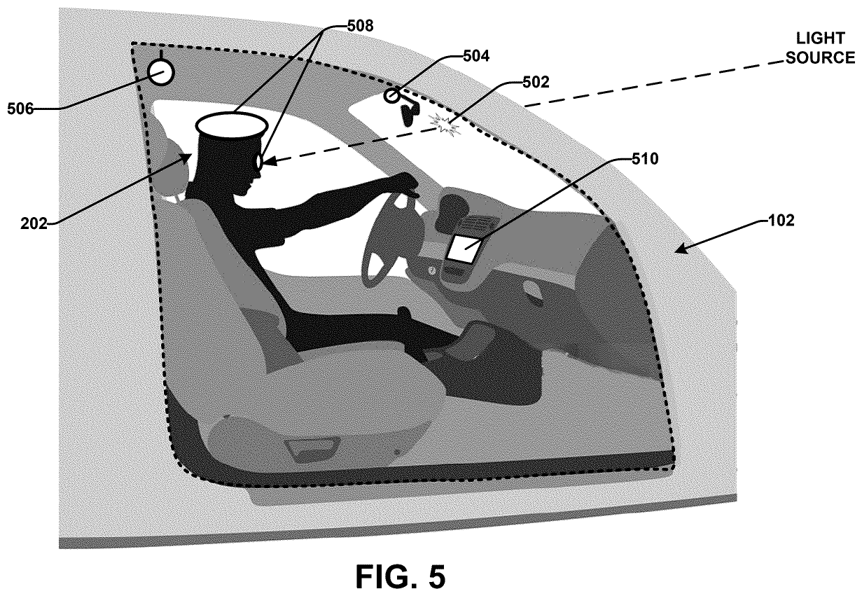

For example, FIG. 5 illustrates a dashboard perspective of an example of vehicle 102 with the front, right-side door removed, in accordance with one or more embodiments described herein. As illustrated in FIG. 5, the driver 202 is experiencing glare as attributed to light being transmitted toward the driver's eyes through the windshield at glare position 302 in accordance with the light beam trajectory indicated via the dashed arrow line.

With reference to FIGS. 1-5, in accordance with the embodiment illustrated in FIG. 4, vehicle 102 can include a camera 504 positioned within the vehicle on or near the rear-view mirror that provides a perspective of the driver's face and/or faces of other passengers of the vehicle. The vehicle 102 can also include another camera 506 mounted to the upper, internal surface of the roof of the vehicle at a position near the driver's seat that provides another perspective or FOV comprising views through all or portions of the front windshield, the front right-side window, the front left side window, and/or other windows of the vehicle. For example, camera 506 may be mounted at a position directly above the driver's seat at a position directly above the driver's head, at a position between the two front seats, at a position directly above the front passenger seat, or the like, and provide a 360-degree FOV or another FOV less than 360 degrees. In some embodiments, using image data captured via camera 504 and/or camera 506 and vehicle 3D map data 140, the glare localization component 130 can determine the FOV of the driver, the angles and intensities of light beams transmitted or reflected through the one or more windows of the vehicle relative to the FOV of the driver, and thus a glare position (e.g., glare position 402) on the one or more windows corresponding to a glare position on a window at which a light beam of significant intensity (e.g., relative to a defined brightness or intensity threshold) is attributed to a glare to the driver 202.

In some embodiments, one or more light sensors located on the windows and/or other physical elements of the vehicle can additionally or alternatively be used to measure the intensity and trajectories of respective light beams relative to the driver's FOV, which in turn can be used by the glare localization component 130 to determine a glare position on one or more windows of the vehicle. To this end, the one or more sensors 126 can include or correspond to light sensors configured to measure the intensity of light beams received at the respective sensors. Depending on the position of the light sensors on or within the vehicle 102, the light sensors can also provide information regarding the point of incidence, the angle of incidence, and/or the trajectory of the light beam or position of the light beam relative to the driver's eyes.

For example, in some implementations, the one or more light sensors can include light sensors integrated at various known points (e.g., as defined in vehicle 3D map data 140) on or within the respective windows of the vehicle 102 which can measure information regarding the intensity of light beams striking the window, the intensity of the light beams, and the angle of incidence. With these implementations, using known or estimated information regarding the FOV of the driver relative to the window (e.g., as determined using one or more cameras 124) and known information about the angle and reflective properties of the window (e.g., included in vehicle 3D map data 140), the glare localization component 130 can determine or infer whether the trajectory of a light beam hitting the window intersects with the driver's FOV. The glare localization component 130 can further determine or infer whether the light beam causes a glare to the driver based on whether the trajectory of a light beam hitting the window intersects with the driver's FOV and the intensity of the light beam. In some embodiments, the one or more sensors 126 can additionally or alternatively include thermal sensors configured to measure the temperature of the window at various points, wherein higher temperatures at a certain points on the window indicate reception of an intense light beam at the certain points.

Additionally, or alternatively, one or more light sensors can be located on or within the vehicle 102 at or near a position corresponding to the position of the driver's head and/or eyes. For example, one or more light sensors may be positioned on or around the upper head rest of the driver's seat, or the like. In other implementations, one or more light sensors can be physically located on or within camera 506 or another position near the driver's eyes.

Still in another example, the one or more light sensors can be integrated on or with a wearable device 508 worn by the driver on or near the driver's head and/or eyes, such as goggles, glasses, a headpiece, or the like. In some implementations of these embodiments, the wearable device can also include a camera that can be used to determine and track the FOV of the driver relative to the windshield and the front left and right windows of the vehicle by the glare localization component 130 based on image data captured via the camera and known and/or estimated information regarding the relative position/orientation of the windows relative to the driver's eyes. With these embodiments, the wearable device 508 can be communicatively coupled to the onboard computer system 106 via any suitable wired or wireless communication technology (e.g., the wearable device 508 can correspond to an example external device of the external devices/systems 120 shown in FIG. 1) and configured to send image data and sensory data captured thereby to the glare localization component 130 in real-time for processing thereof in association with identifying, determining and tracking a glare position/glare region attributed to a glare to the driver 202 on one or more windows of the vehicle.

With these embodiments, the glare localization component 130 can determine whether a light beam received at the respective light sensors and/or camera integrated on or withing the wearable device 508 causes glare to the driver based on the intensity of the light beam and the angle of incidence of the light beam as received at the respective light sensors relative to the known position of the light sensors relative to the driver's FOV and/or eyes (e.g., as defined in the vehicle 3D map data 140 and/or determined using one or more cameras 124). The glare localization component 130 can further determine the glare position of the light beam causing the glare on a corresponding window of the vehicle 102 using triangulation or other mapping and localization algorithms and known information defining the relative positions and angles of the windows relative to the position of the driver's eye and FOV and the point and angle of incidence of the light beam relative to the driver's eyes/FOV.

Additionally, or alternatively, the glare localization component 130 can determine and track a glare position based on reception of user input from the driver or a passenger of the vehicle indicating the glare position. For example, in some implementations, the user input can comprise gesture input corresponding to pointing to the glare position or temporarily directing the driver's line of sight toward the glare position. With these embodiments, using vehicle 3D map data and image data captured via one or more cameras located on or within the vehicle 102 (e.g., 504, camera 506, one or more cameras integrated on or within wearable device 508, or the like), and gesture recognition technology (e.g., based on analysis of the image data) and triangulation algorithms or the like, the glare localization component 130 can determine the point or location on a window of the vehicle that the user is pointing to or directing their line of sight to. The user input can also include some type of additional signal provided by the user confirming that the user is noting the particular point as a glare position in association with a request to mitigate the glare. For example, the additional input may include voice input to this end, another form of gesture input to this end, or the like. In another example, the additional input can be based on the user activating the glare mitigation system 104 via any suitable human-machine interface 108 and then performing the gesture input to indicate the glare position, such as pressing a button on the vehicle (e.g., a physical button, a graphical button displayed on a graphical user interface of a touchscreen display device 510) coupled to the onboard computer system 106 that provides a request signal to the of a glare mitigation system 104 requesting mitigation of a glare. To this end, following pressing the button or otherwise initiating the glare mitigation process, the glare mitigation system 104 can activate the camera (e.g., camera 502, 506, one or more cameras integrated on or within wearable device 508, or the like) to monitor the image data for received user gesture input indicating the glare position.

Additionally, or alternatively, the user input can comprise a selection of the glare position on a graphical representation of the one or more windows as displayed via a touchscreen display device 510 positioned within the vehicle. For example, as illustrated in FIG. 5, vehicle 102 can comprise a touchscreen display device 510 located on or near the dashboard. With these embodiments, the glare mitigation functionality provided by the glare mitigation system 104 can be partially controlled and operated by a user via corresponding interactive graphical user interface displayed on the touchscreen display device 510. In this regard, in some embodiments, the glare localization component 130 can provide an interactive graphical user interface that allows the user to control the glare mitigation system 104, including controlling selecting a glare position, tailoring the size of the glare position, and directing the glare mitigation system to minimize or block the glare via the one or more antiglare devices 122.

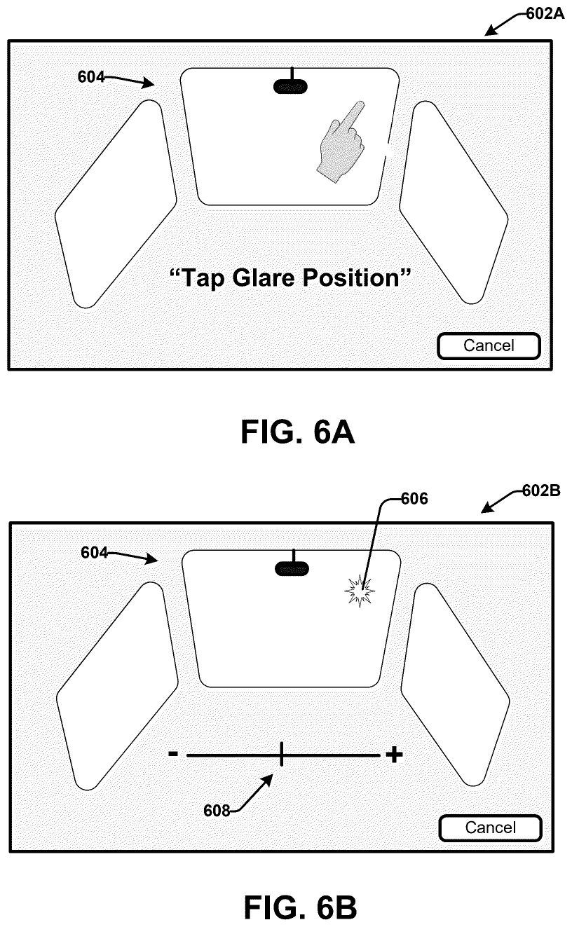

For example, FIGS. 6A and 6B illustrate an example graphical user interface (GUI) of the vehicle glare mitigation system 104 that facilitates localizing a glare position on one or more windows of a vehicle, in accordance with one or more embodiments described herein. In accordance with this example, the glare mitigation system 104 is used to mitigate glare to the driver of the vehicle and thus involves only those windows within the FOV of the driver, which include the front left and right windows and the windshield. In this regard, FIG. 6A presents a screen 602A of the GUI that can be presented to the driver via the glare mitigation system to facilitate selecting a glare position. Screen 602A include a simplified representation 604 of the windshield and the front left and right windows of the vehicle and provides for receiving user input indicating the glare position via tapping or otherwise touching the glare position on the corresponding window of the representation 604. In this example, the hand icon corresponds to the hand of the driver (or a passenger) tapping the glare position, which in this case corresponds to a location near the upper right corner of the windshield. In some embodiments, in response to providing user input via screen 602A tapping the glare position on the corresponding window representation, the glare localization component 130 can determine the corresponding actual glare position on the actual window and the antiglare component 132 can control the one or more antiglare devices to cause the one or more antiglare devices 122 to minimize the glare.

FIG. 6B presents another screen 602B that can be presented via the GUI in response to selection of the glare position via screen 602A. Screen 602B includes a glare icon placed at the selected glare position. Screen also include as sizing bar 608 that can be used to provide input increasing or decreasing the size of the glare icon 606, which corresponds to user input increasing or decreasing the size of the glare region on the window that is dimmed or shaded (e.g., via increasing the opacity or tint level thereof) in accordance with embodiments in which the antiglare device employed includes or corresponds to a smart film or smart window. In other implementations, the size of the glare icon 606 may be adjusted via screen 606 using a pinching touchscreen input or the like. In some implementations, the GUI can also allow the user to provide input moving the glare position in association with moving the glare icon 606 using any suitable touchscreen input commands.

With reference again to FIG. 1, in some embodiments, the glare mitigation system 104 can include a context component 134 that determines context information regarding a current driving context of the vehicle 102, and wherein the glare localization component 130 determines and tracks the glare position based on the context information. In this regard, the context information can include information that indicates the current position/orientation and intensity of the sun and other light sources relative to the vehicle that may cause glare to a driver of the vehicle (or another passenger of the vehicle). To this end, the glare localization component 130 can employ such context information to facilitate determining or inferring whether the driver or another passenger is experiencing glare and the glare position. For example, the context information can include but is not limited to, a current time of day, a current location of the vehicle, a current route of the vehicle, a current relative position and orientation between of a source of light attributed to the glare relative to the current field of view of the driver, and a current intensity of the source of light. To facilitate this end, the context component 134 can access various external resources (e.g., external systems/devices 120) accessible via any suitable communication network (e.g., the Internet or the like) to determine or infer the context information, as well as other onboard vehicle systems, such as an onboard navigation system, another navigation system coupled to the onboard computer system (e.g., a smartphone located within the vehicle providing navigation or the like).

In some embodiments, the glare localization component 130 can also employ artificial intelligence and machine learning techniques (e.g., provided by artificial intelligence component 136) to facilitate identifying or determining and tracking a glare position. For example, using various machine learning and AI techniques, the AI component 136 can facilitate inferring the FOV of the driver, sources of glare light, positions of glare beams relative to the vehicle, incidence points of light beams hitting the vehicle windows, incidence angles of the light beams, intensities of the light beams, and corresponding angles and intensities of light beams entering the FOV of the driver based on the context information described above and any other sensory information captured via the one or more sensors 126 and/or the one or more cameras 124. The AI component 136 can also provide for inferring any of the context information described above using various machine learning and/or AI techniques. The AI component 136 can also uses AI technology to infer when a driver or passenger of the vehicle is experiencing glare and the glare position on one or more windows of the vehicle.

In some embodiments, to facilitate generating such inferences, the AI component 136 can also analyze tracked user data 142. In this regard, the tracked user data 142 can include or correspond to tracked data for a driver of the vehicle 102 (and/or other passengers of the vehicle) regarding their usage of the glare mitigation system 104 over time in combination with information regarding the context of the vehicle. For example, the tracked user data 142 can track when and where (e.g., glare positions) the driver experiences glare in association with driving the vehicle about their normal driving patterns and contexts. For instance, assume a driver drives the same route to work every morning between 7am and 8am and during a certain time of year, the position of the sun in the morning along the driver's route causes a glare to the driver at the same glare position on the right front window. In accordance with this example, the AI component 136 can learn the driver's patterns and needs for minimizing glare under this context based on tracked user data 142 indicated this pattern over time in association with the driver using the glare mitigation system 104. In response detection of this same context in the future, the AI component 136 can further inform the glare localization component 130 at the time of detection of such context of the glare position and/or direct the antiglare component 132 to automatically mitigate the glare (e.g., using the one or more antiglare devices 122) accordingly.

To facilitate this end, the AI component 136 can employ various types of machine learning techniques for learning explicitly or implicitly. Inferring or learning can employ a probabilistic or statistical-based analysis to infer an action that is to be executed. For example, in some implementations, a support vector machine (SVM) classifier can be employed. Other learning approaches that can be employed by the AI component 136 can include usage of neural networks (e.g., including deep neural networks, deep adversarial neural networks, convolutional neural networks, and the like), Bayesian networks, decision trees, a nearest neighbor algorithms, boosting algorithm, gradient boosting algorithms, linear regression algorithms, k-means clustering algorithms, association rules algorithms, q-learning algorithms, temporal difference algorithm, and probabilistic classification models providing different patterns of independence can be employed. Learning as used herein also is inclusive of statistical regression that is utilized to develop models of priority.

As will be readily appreciated from the subject specification, the subject innovation can employ learning classifiers that are explicitly trained (e.g., via a generic training data) as well as implicitly trained (e.g., via observing user behavior, receiving extrinsic information) so that the learning classifier is used to automatically determine according to predetermined criteria which action to take. For example, SVM's can be configured via a learning or training phase within a learning classifier constructor and feature selection module. A learning classifier is a function that maps an input attribute vector, k=(k1, k2, k3, k4, kn), to a confidence that the input belongs to a learning class—that is, f(k)=confidence(class).

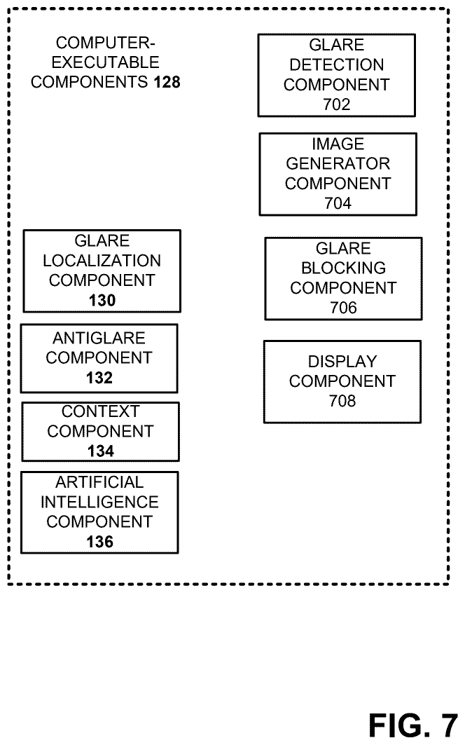

Turning now to the drawings, FIG. 7 illustrates a block diagram of, additionally, or alternatively, exemplary system 100 that facilitates mitigating glare to a driver of a vehicle, in accordance with one or more embodiments described herein. The computer-executable components 128 further includes (but are not limited to) a glare detection component 702, an image generator component 704, a glare blocking component 706 and a display component 708.

In various embodiments, the glare detection component 702 is that detects glare on a window from an external light source, wherein the glare detection component 702 detects glare on the front windshield window, the left-side window, the right-side window and a rear windshield window. In an aspect, the glare detection component 702 estimates the location of glare on the windshield based on sensor data from the occupant's seat position and determines and tracks the current field of view of the driver using one or more cameras positioned within the vehicle. In some embodiments, the glare detection component 702 detects glare using a wearable device wirelessly connected to the glare detection component 702 and placed on driver's face, the wearable device comprising one or more cameras that tracks the current field of view of the driver. In some embodiments, multiple sensors are placed throughout the occupant compartment of the vehicle (e.g., inside the vehicle), or alternatively cameras placed outside the vehicle, that detect glare on the windshield that may impact the driver or the occupants. The sensors may be placed on the head rest located behind the occupant, wherein the sensors can be placed at the eye level of the occupant. For example, cameras are placed at eye level on the head rest to detect the glare location on the windshield and the glare detection component 702 is connected to the camera that detects glare coming from the outside. In an aspect, a glare location component (not shown) can locate or estimate the location of the glare on the windshield, right widow, left window and rear window using various methods discussed above.

In various embodiments, the display component 708 is configured to one or more virtual windows (described in FIG. 6) on an infotainment system whereby allowing a driver or occupant to manually select a portion of the virtual window to block the glare. The one or more virtual windows can comprise display a first window (e.g., front windshield), second window (e.g., right side window), window (e.g., left side window), and fourth window (e.g., rear windshield). In some embodiments, the display component 708 is configured to display an interactive rendition (e.g., an interactive image) of front windshield, left side and right-side windows. The front windshield rendition also includes rendition of rear-view mirror. The images include all the spots where the glare is impacting the occupant. This rendition is based on the location of the occupant. For example, the driver with have a driver seat rendition, front seat passenger will have a front seat rendition., etc. Thus, the rendition is based on seat specific with sensor that detect the glare for the seat. Thus, all the glare spots impacting the driver will be displayed on the driver seat rendition. Similarly, all the glare spots impacting the front passenger will be displayed on the front seat rent rendition. The human-machine interface 108 may be used to interact with the display of the rendition. In an aspect, the display component 708 renders an interactive image of a front windshield, a left-side window, a right-side window and rearview mirror. Once the interactive image is displayed, the display component comprises a user interface for drawing out a region of the virtual window to block out glaring light. For example, the system identifies all the glare spots on any of the windows and displays them on the virtual image of the windows. The system allows the user to select the window and zoom in/out. The occupant can tap on each glare spot and/or draw out a region to block our glaring light. If the occupant taps on the glare spot, a default circle size will be used to block out that glare. Alternatively, the occupant can customize the area to block out using a drawing method.

In various embodiments, the image generator component 704 generates an image covering (e.g., anti-glare image) one or more glare spots based on information from the glare detection component 702 and the display component. Once glare detection component 702 has identified one or more glare spots and the occupant has selected the glare spots to block/darken using the display component, the image generated an anti-glare image for each window having glare spots. For example, if the glare is coming from the front windshield, the image generator component 704 creates an anti-glare image that darkens the area using various default images (e.g., a black, dark color, or a darker version of the colors observed outside). In an aspect, the anti-glare image may be an image of what the occupant observes with darkened spots to block or reduce the glare.

In various embodiments, the glare blocking component 706 is configured to projects an anti-glare image on the window to darken glare spots identified on the virtual window. In some embodiments, the glare blocking component 706 comprises a 360-degree projector (the projector image not shown) having four projection outputs that can project an image on each window of the car, including on the rear-view mirror. Once the driver or the passenger has selected the spot to initiate blocking of the glare by tapping on the displayed spot or select an area to cover one or more glare spot, glare blocking component 706 can cover the glare spots by projecting an image that will darken only the identified glare spots. The 360-degree projector can be used to project the anti-glare image on all the windows of the car. As discussed above, the image generator component 704 utilizes information from the glare component 702 and display component 708 to generate an image that only covers one or more glare spots. The projector can permanently be mounted on the roof or placed anywhere in the vehicle. It should be noted that the projection on the windows can be calibrated using the display of the infotainment system. In an aspect, the projector comprises one or more (e.g., one for each window) projecting sources. The projection area of each projecting source can be adjusted manually or automatically. In an aspect, the projector is connected to the vehicle control system via wireless or wired connection. The control system provides vehicle information to the projector that is used to determine the size of each window. The projector can further provide placement of the projector within the vehicle for best results. The image or the projection can be displayed on the infotainment display for exact calibration. In an aspect, the 360-degree projectors can be based on DLP (Digital Light Processing) or laser projection technology. Unlike traditional projectors that project content onto a flat surface (such as a screen or wall), a 360-degree projector emits light in all directions. It creates an immersive experience by projecting visuals onto the surrounding environment, including walls, floors, and even the ceiling. In an aspect, the 360-degree projector provides uniform brightness across all directions comprising optics and lens designed to distribute light evenly. A projector calibration component (not shown) is provided to calibrate the projector once is placed and connected to the vehicle system 100.

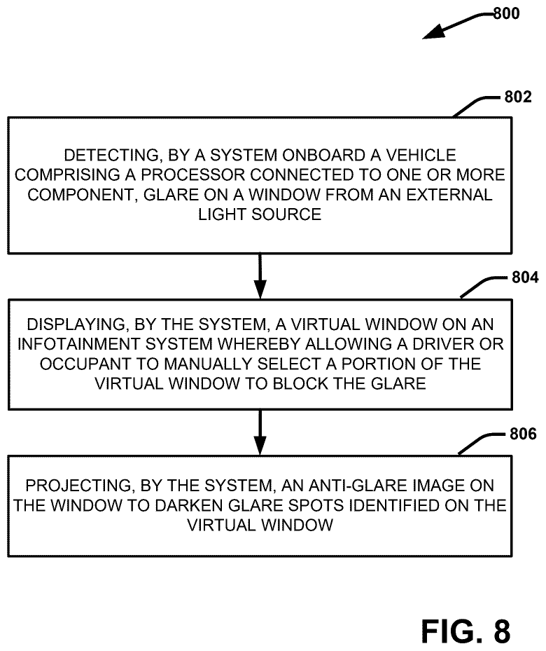

FIG. 8 illustrates a block flow diagram of an example, non-limiting computer-implemented method 800 for mitigating glare to a driver of a vehicle in accordance with one or more embodiments described herein. Method 800 comprises, at 802, detecting, by a system onboard a vehicle comprising a processor connected to one or more component (e.g., the glare detection component), glare on a window from an external light source. At 804, method 800 comprises displaying, by the system (e.g., the display component), a virtual window on an infotainment system whereby allowing a driver or occupant to manually select a portion of the virtual window to block the glare. At 806, method 800 comprises projecting, by the system (e.g., the glare blocking component), an anti-glare image on the window to darken glare spots identified on the virtual window.

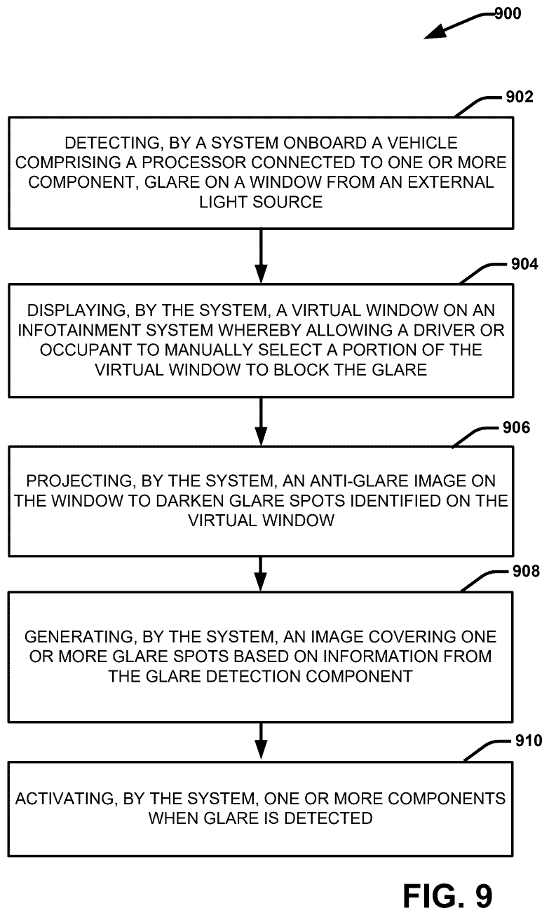

FIG. 9 illustrates a block flow diagram of an example, non-limiting computer-implemented method 900 for mitigating glare to a driver of a vehicle in accordance with one or more embodiments described herein. Method 900 comprises, at 902, detecting, by a system onboard a vehicle comprising a processor connected to one or more component (e.g., the glare detection component), glare on a window from an external light source. At 904, method 900 comprises displaying, by the system (e.g., the display component), a virtual window on an infotainment system whereby allowing a driver or occupant to manually select a portion of the virtual window to block the glare. At 906, method 900 comprises projecting, by the system (e.g., the glare blocking component), an anti-glare image on the window to darken glare spots identified on the virtual window. At 908, method 900 comprises generating, by the system (e.g., the image generator component), an image covering one or more glare spots based on information from the glare detection component. At 910, method 900 comprises activating, by the system, one or more components when glare is detected.

Systems described herein can be coupled (e.g., communicatively, electrically, operatively, optically, inductively, acoustically, etc.) to one or more local or remote (e.g., external) systems, sources, and/or devices (e.g., electronic control systems (ECU), classical and/or quantum computing devices, communication devices, etc.). For example, system 100 (or other systems, controllers, processors, etc.) can be coupled (e.g., communicatively, electrically, operatively, optically, etc.) to one or more local or remote (e.g., external) systems, sources, and/or devices using a data cable (e.g., High-Definition Multimedia Interface (HDMI), recommended standard (RS), Ethernet cable, etc.) and/or one or more wired networks described below.

In some embodiments, systems herein can be coupled (e.g., communicatively, electrically, operatively, optically, inductively, acoustically, etc.) to one or more local or remote (e.g., external) systems, sources, and/or devices (e.g., electronic control units (ECU), classical and/or quantum computing devices, communication devices, etc.) via a network. In these embodiments, such a network can comprise one or more wired and/or wireless networks, including, but not limited to, a cellular network, a wide area network (WAN) (e.g., the Internet), and/or a local area network (LAN). For example, system 100 can communicate with one or more local or remote (e.g., external) systems, sources, and/or devices, for instance, computing devices using such a network, which can comprise virtually any desired wired or wireless technology, including but not limited to: powerline ethernet, VHF, UHF, AM, wireless fidelity (Wi-Fi), BLUETOOTH®, fiber optic communications, global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, Session Initiation Protocol (SIP), ZIGBEE®, RF4CE protocol, WirelessHART protocol, L-band voice or data information, 6LoWPAN (IPv6 over Low power Wireless Area Networks), Z-Wave, an ANT, an ultra-wideband (UWB) standard protocol, and/or other proprietary and non-proprietary communication protocols. In this example, system 100 can thus include hardware (e.g., a central processing unit (CPU), a transceiver, a decoder, an antenna (e.g., a ultra-wideband (UWB) antenna, a BLUETOOTH® low energy (BLE) antenna, etc.), quantum hardware, a quantum processor, etc.), software (e.g., a set of threads, a set of processes, software in execution, quantum pulse schedule, quantum circuit, quantum gates, etc.), or a combination of hardware and software that facilitates communicating information between a system herein and remote (e.g., external) systems, sources, and/or devices (e.g., computing and/or communication devices such as, for instance, a smart phone, a smart watch, wireless earbuds, etc.).

Systems herein can comprise one or more computer and/or machine readable, writable, and/or executable components and/or instructions that, when executed by processor (e.g., a processing unit 110 which can comprise a classical processor, a quantum processor, etc.), can facilitate performance of operations defined by such component(s) and/or instruction(s). Further, in numerous embodiments, any component associated with a system herein, as described herein with or without reference to the various figures of the subject disclosure, can comprise one or more computer and/or machine readable, writable, and/or executable components and/or instructions that, when executed by a processor, can facilitate performance of operations defined by such component(s) and/or instruction(s). Consequently, according to numerous embodiments, system herein and/or any components associated therewith as disclosed herein, can employ a processor (e.g., processing unit 116) to execute such computer and/or machine readable, writable, and/or executable component(s) and/or instruction(s) to facilitate performance of one or more operations described herein with reference to system herein and/or any such components associated therewith.

Systems herein can comprise any type of system, device, machine, apparatus, component, and/or instrument that comprises a processor and/or that can communicate with one or more local or remote electronic systems and/or one or more local or remote devices via a wired and/or wireless network. All such embodiments are envisioned. For example, a system (e.g., a system 100 or any other system or device described herein) can comprise a computing device, a general-purpose computer, field-programmable gate array, AI accelerator application-specific integrated circuit, a special-purpose computer, an onboard computing device, a communication device, an onboard communication device, a server device, a quantum computing device (e.g., a quantum computer), a tablet computing device, a handheld device, a server class computing machine and/or database, a laptop computer, a notebook computer, a desktop computer, wearable device, internet of things device, a cell phone, a smart phone, a consumer appliance and/or instrumentation, an industrial and/or commercial device, a digital assistant, a multimedia Internet enabled phone, a multimedia players, and/or another type of device.

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers (e.g., ruggedized personal computers), field-programmable gate arrays, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, optic, infrared, and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors, field-programmable gate array, AI accelerator application-specific integrated circuit, or other suitable processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data. It is noted that unified Extensible Firmware Interface(s) can be utilized herein.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a disc 1022 such as a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

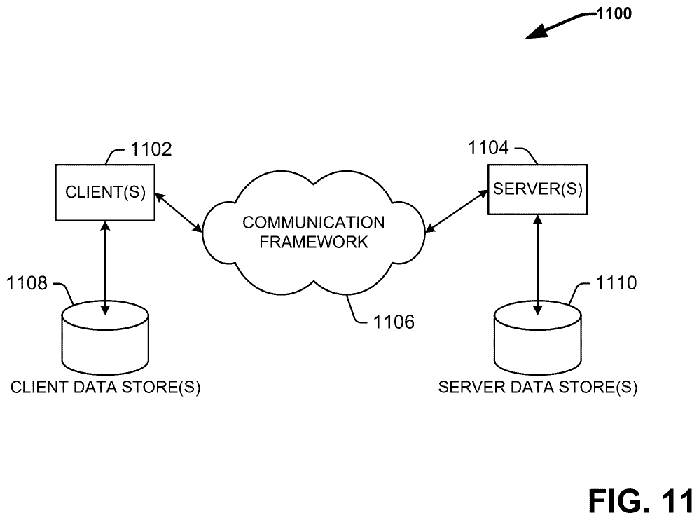

Referring now to FIG. 11, there is illustrated a schematic block diagram of a computing environment 1100 in accordance with this specification. System 1100 includes one or more client(s) 1102, (e.g., computers, smart phones, tablets, cameras, PDA's). The client(s) 1102 can be hardware and/or software (e.g., threads, processes, computing devices). The client(s) 1102 can house cookie(s) and/or associated contextual information by employing the specification, for example.

The system 1100 also includes one or more server(s) 1104. The server(s) 1104 can also be hardware or hardware in combination with software (e.g., threads, processes, computing devices). The servers 1104 can house threads to perform transformations of media items by employing aspects of this disclosure, for example. One possible communication between a client 1102 and a server 1104 can be in the form of a data packet adapted to be transmitted between two or more computer processes wherein data packets may include coded analyzed headspaces and/or input. The data packet can include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104. Further, the client(s) 1102 can be operatively connected to one or more server data store(s) 1110.

In one exemplary implementation, a client 1102 can transfer an encoded file, (e.g., encoded media item), to server 1104. Server 1104 can store the file, decode the file, or transmit the file to another client 1102. It is noted that a client 1102 can also transfer uncompressed file to a server 1104 and server 1104 can compress the file and/or transform the file in accordance with this disclosure. Likewise, server 1104 can encode information and transmit the information via communication framework 1106 to one or more clients 1102.

The illustrated aspects of the disclosure can also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art can recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature can be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Further aspects of the invention are provided by the subject matter of the following clauses:
1. A system, comprising:
   a memory that stores computer executable components of a vehicle; and
   a processor that executes the computer executable components stored in the memory, wherein the computer executable components comprise:
   a glare detection component that detects glare on a window from an external light source;
   a display component that displays a virtual window on an infotainment system whereby allowing a driver or occupant to manually select a portion of the virtual window to block the glare; and
   a glare blocking component that projects an anti-glare image on the window to darken glare spots identified on the virtual window.
2. The system of one or more preceding clauses, wherein the glare detection component is connected to a camera placed at eye level on the headrest of a vehicle seat and the glare detection component activates the display component and glare blocking component when glare is detected.
3. The system of one or more preceding clauses, wherein the computer-executable components further comprise:
an image generator component that generates an image covering one or more glare spots based on information from the glare detection component and the display component.
4. The system of one or more preceding clauses, wherein the glare blocking component utilizes a 360-degree projector, positioned within the vehicle, to project the anti-glare image on a front windshield window, a left-side window, a right-side window and a rear windshield window when the glare spot was identified using the image of the rearview mirror.
5. The system of one or more preceding clauses, wherein the glare detection component detects glare on the front windshield window, the left-side window, the right-side window and a rear windshield window.
6. The system of one or more preceding clauses, wherein the display component renders an interactive image of a front windshield, a left-side window, a right-side window and rearview mirror.
7. The system of one or more preceding clauses, wherein the display component comprises a user interface for drawing out a region of the virtual window to block out glaring light.
8. The system of one or more preceding clauses, wherein the glare detection component estimates the location of glare on the windshield based on sensor data from the occupant's seat position.
9. The system of one or more preceding clauses, wherein the glare detection component determines and tracks the current field of view of the driver using one or more cameras positioned within the vehicle.
10. The system of one or more preceding clauses, wherein the glare detection component detects glare using a wearable device wirelessly connected to the glare detection component and placed on driver's face, the wearable device comprising one or more cameras that tracks the current field of view of the driver.
11. A method, comprising:
detecting, by a system onboard a vehicle comprising a processor, glare on a window from an external light source;
displaying, by the system, a virtual window on an infotainment system whereby allowing a driver or occupant to manually select a portion of the virtual window to block the glare; and
projecting, by the system, an anti-glare image on the window to darken glare spots identified on the virtual window.
12. The method of one or more preceding clauses, further comprising:
   generating, by the system, an image covering one or more glare spots based on information from the glare detection component; and
   activating, by the system, one or more components when glare is detected.
13. The method of one or more preceding clauses, wherein the projecting comprises utilizing a 360-degree projector, positioned within the vehicle, to project the anti-glare image on a front windshield window, the left-side window, the right-side window and a rear windshield window when the glare spot was identified using the image of the rearview mirror.
14. The method of one or more preceding clauses, wherein the detecting comprises detecting glare on the front windshield window, the left-side window, the right-side window and a rear windshield window.
15. The method of one or more preceding clauses, wherein displaying comprises rendering an interactive image of a front windshield, a left-side window, a right-side window and rearview mirror.
16. The method of one or more preceding clauses, wherein displaying comprises utilizing a user interface for drawing out a region of the virtual window to block out glaring light.
17. The method of one or more preceding clauses, wherein detecting comprises estimating location of glare on the windshield based on sensor data from the occupant's seat position.
18. The method of one or more preceding clauses, wherein detecting comprises determining and tracking the current field of view of the driver using one or more cameras positioned within the vehicle
19. A non-transitory machine-readable storage medium, comprising executable instructions that, when executed by a processor onboard a vehicle, facilitate performance of operations, comprising:
   detecting glare on a window from an external light source;
   displaying a virtual window on an infotainment system whereby allowing a driver or occupant to manually select a portion of the virtual window to block the glare;
   projecting, by the system, an anti-glare image on the window to darken glare spots identified on the virtual window;
   generating an image covering one or more glare spots based on information from the glare detection component; and
   activating one or more components when glare is detected.
20. The non-transitory machine-readable storage medium of one or more preceding clauses, further comprising executable instructions that, when executed by a processor onboard a vehicle, facilitate performance of operations, comprising:
   generate, by the system, an image covering one or more glare spots based on information from the glare detection component; and
   activate, by the system, one or more components when glare is detected.
21. Any suitable combination of system clauses 1-10.
22. Any suitable combination of method clauses 11-18.
23. Any suitable combination of non-transitory machine-readable storage medium clauses 19-20.
24. Any suitable combination of system clauses 1-20.

What is claimed is:

1. A system, comprising:
a memory that stores computer executable components of a vehicle; and
a processor that executes the computer executable components stored in the memory, wherein the computer executable components comprise:
a glare detection component that detects glare on a window from an external light source;
a display component that displays a virtual window on an infotainment system whereby allowing a driver or occupant to manually select a portion of the virtual window to block the glare; and
a glare blocking component that projects an anti-glare image on the window to darken glare spots identified on the virtual window.

2. The system of claim 1, wherein the glare detection component is connected to a camera placed at eye level on the headrest of a vehicle seat and the glare detection component activates the display component and glare blocking component when glare is detected.

3. The system of claim 1, wherein the computer-executable components further comprise:
an image generator component that generates an image covering one or more glare spots based on information from the glare detection component and the display component.

4. The system of claim 1, wherein the glare blocking component utilizes a 360-degree projector, positioned within the vehicle, to project the anti-glare image on a front windshield window, a left-side window, a right-side window and a rear windshield window when the glare spot was identified using the image of the rearview mirror.

5. The system of claim 4, wherein the glare detection component detects glare on the front windshield window, the left-side window, the right-side window and a rear windshield window.

6. The system of claim 1, wherein the display component renders an interactive image of a front windshield, a left-side window, a right-side window and rearview mirror.

7. The system of claim 1, wherein the display component comprises a user interface for drawing out a region of the virtual window to block out glaring light.

8. The system of claim 1, wherein the glare detection component estimates the location of glare on the windshield based on sensor data from the occupant's seat position.

9. The system of claim 8, wherein the glare detection component determines and tracks the current field of view of the driver using one or more cameras positioned within the vehicle.

10. The system of claim 1, wherein the glare detection component detects glare using a wearable device wirelessly connected to the glare detection component and placed on driver's face, the wearable device comprising one or more cameras that tracks the current field of view of the driver.

11. A method, comprising:
detecting, by a system onboard a vehicle comprising a processor, glare on a window from an external light source;
displaying, by the system, a virtual window on an infotainment system whereby allowing a driver or occupant to manually select a portion of the virtual window to block the glare; and
projecting, by the system, an anti-glare image on the window to darken glare spots identified on the virtual window.

12. The method of claim 11, further comprising:
generating, by the system, an image covering one or more glare spots based on information from the glare detection component; and
activating, by the system, one or more components when glare is detected.

13. The method of claim 11, wherein the projecting comprises utilizing a 360-degree projector, positioned within the vehicle, to project the anti-glare image on a front windshield window, the left-side window, the right-side window and a rear windshield window when the glare spot was identified using the image of the rearview mirror.

14. The method of claim 11, wherein the detecting comprises detecting glare on the front windshield window, the left-side window, the right-side window and a rear windshield window.

15. The method of claim 11, wherein displaying comprises rendering an interactive image of a front windshield, a left-side window, a right-side window and rearview mirror.

16. The method of claim 11, wherein displaying comprises utilizing a user interface for drawing out a region of the virtual window to block out glaring light.

17. The method of claim 11, wherein detecting comprises estimating location of glare on the windshield based on sensor data from the occupant's seat position.

18. The method of claim 11, wherein detecting comprises determining and tracking the current field of view of the driver using one or more cameras positioned within the vehicle.

19. A non-transitory machine-readable storage medium, comprising executable instructions that, when executed by a processor onboard a vehicle, facilitate performance of operations, comprising:
detecting glare on a window from an external light source;
displaying a virtual window on an infotainment system whereby allowing a driver or occupant to manually select a portion of the virtual window to block the glare;
projecting, by the system, an anti-glare image on the window to darken glare spots identified on the virtual window;
generating an image covering one or more glare spots based on information from the glare detection component; and
activating one or more components when glare is detected.

20. The non-transitory machine-readable storage medium of claim 19, further comprising executable instructions that, when executed by a processor onboard a vehicle, facilitate performance of operations, comprising:
generate, by the system, an image covering one or more glare spots based on information from the glare detection component; and
activate, by the system, one or more components when glare is detected.
